(19) United States
(12) Patent Application Publication
(10) Pub. No.: US 2017/0257663 A1
(43) Pub. Date: Sep. 7, 2017

(54) RECEPTION APPARATUS AND TRANSMISSION APPARATUS

(71) Applicant: Sharp Kabushiki Kaisha, Sakai City, Osaka (JP)

(72) Inventors: Tomoko AONO, Sakai City (JP); Hisao KUMAI, Sakai City (JP); Maki TAKAHASHI, Sakai City (JP); Shuhichi WATANABE, Sakai City (JP)

(21) Appl. No.: 15/505,970

(22) PCT Filed: Aug. 27, 2015
(86) PCT No.: PCT/JP2015/074281

§ 371 Date: Feb. 23, 2017

(30) Foreign Application Priority Data
Aug. 27, 2014 (JP) 2014-173267
Oct. 10, 2014 (JP) 2014-209445

(51) Int. Cl. H04N 21/435; H04N 21/8545; H04N 21/434; H04N 21/84; H04H 20/93; H04N 21/44

(52) U.S. Cl. CPC H04N 21/435; H04H 20/93; H04N 21/44; H04N 21/434; H04N 21/84; H04N 21/8545

(57) ABSTRACT

Different applications are activated for respective multiple programs. A component demultiplexing unit (34) that receives an MH-AIT (141) indicating an application corresponding to each of packages, a combining unit (38) and an audio decoding unit (36) that reproduce one of the packages, and a data broadcasting control unit (37) that controls an application corresponding to a package, which is being reproduced, by referring to the MH-AIT (141) are included.

### TECHNICAL FIELD

The present invention relates to a reception apparatus that receives a multiple program content in which a plurality of packages are allocated to one channel, a method for controlling the reception apparatus, a transmission apparatus that transmits the content, a method for controlling the transmission apparatus, a control program of the apparatuses, and a recording medium in which the control program is recorded.

### BACKGROUND ART

Currently, the broadcasting standard for the ultra-high definition television broadcasting (8K or 4K broadcasting) is under development. The data broadcasting standard for the ultra-high definition television broadcasting is also under development.

In the Hybridcast as a broadcasting-communication integrated service, service of which has been started recently, an application of data broadcasting is able to be activated in cooperation with a program on the basis of an application information table (AIT).

### CITATION LIST

### Non Patent Literature

NPL 1: Association of Radio Industries and Businesses, Data Coding and Transmission Specification for Digital Broadcasting, Standard, ARIB STD-B24, Version 5.5 (Volume 3), published on December 2011
NPL 2: Association of Radio Industries and Businesses, Video Coding, Audio Coding, and Multiplexing Specifications for Digital Broadcasting, Standard, ARIB STD-B32, Version 2.2, published on July 2009
NPL 3: Association of Radio Industries and Businesses, MMT-Based Media Transport Scheme for Digital Broadcasting, Standard, ARIB STD-B60, Version 1.0, published on July 2014
NPL 4: IPTV Forum Japan, IPTV standards, Integrated Broadcast-Broadband System Specification IPTVFJ STD-0010 Version 1.0, P 16 to P 34, P 53 to P 59, published on Mar. 22, 2013

### SUMMARY OF INVENTION

### Technical Problem

In the broadcasting standard for the ultra-high definition television broadcasting, which is currently under development, not only the 8K broadcasting but also the broadcasting in 4K multichannel program are also considered to be standardized. In the current standard for the ultra-high definition television broadcasting, however, only one AIT is able to be linked to one broadcasting service. Thus, it is difficult to activate different applications for respective multiple programs in a broadcasting content in 4K multichannel program.

The invention has been made in view of the aforementioned problem and an object thereof is to realize a reception apparatus, a transmission apparatus, a transmission system, a method for controlling the reception apparatus, a method for controlling the transmission apparatus, a control program, and a recording medium that are able to activate different applications for respective multiple programs.

### Solution to Problem

In order to solve the aforementioned problem, a transmission apparatus according to an aspect of the invention is a transmission apparatus that transmits a content. The transmission apparatus includes a transmission unit that transmits the content and a management table in which an application specification descriptor is described. The application specification descriptor includes specification information for specifying a location at which an application information table is able to be acquired.

### Advantageous Effects of Invention

According to an aspect of the invention, an effect is exerted that, for each of multichannels (multiple program content), an application corresponding to the multichannel is able to be activated.

### BRIEF DESCRIPTION OF DRAWINGS

FIG. 1 is a block diagram illustrating an example of a configuration of a content transmission system according to Embodiment 1 of the invention and a main portion of a transmission apparatus and a reception apparatus included in the system.

FIG. 2 illustrates an example of a data structure of a content transport unit according to Embodiment 1 of the invention.

FIG. 3 illustrates an example of syntax of a PA message that is control information of the content.

FIG. 4 illustrates an example of syntax of an MPT included in the PA message.

FIG. 5 illustrates an example of syntax of a PLT included in the PA message.

FIG. 6 illustrates an example of syntax of an M2 section message that is control information of the content.

FIG. 7 illustrates an example of syntax of an MH-AIT included in the M2 section message.

FIG. 8 illustrates an example of an application identifier described in the MH-AIT.

FIG. 9 illustrates another example of an application identifier described in the MH-AIT.

FIG. 10 illustrates an example of an MPT generated by the transmission apparatus.

FIG. 11 illustrates an example of an application list generated by the reception apparatus.

FIG. 12 is a flowchart illustrating an example of content transmission processing of the transmission apparatus.

FIG. 13 is a flowchart illustrating an example of content reception processing of the reception apparatus.

FIG. 14 illustrates an example of syntax of an MH-application descriptor described in an MH-AIT according to Embodiment 2 of the invention.

FIG. 15 illustrates an example of syntax of an MH-simple application location descriptor described in an MH-AIT according to Embodiment 3 of the invention.

FIG. 16 illustrates an example of an application list generated by a reception apparatus according to Embodiment 3 of the invention.

FIG. 17 illustrates an example of a data structure of a content transport unit according to Embodiment 4 of the invention.

FIG. 18 illustrates an example of an MPT generated by a transmission apparatus according to Embodiment 4 of the invention.

FIG. 19 is a flowchart illustrating an example of content transmission processing by the transmission apparatus.

FIG. 20 is a flowchart illustrating an example of content reception processing by a reception apparatus according to Embodiment 4 of the invention.

FIG. 21 illustrates an example of syntax of an AIT binding descriptor described in a first descriptor of an MH-AIT according to Embodiment 5 of the invention.

FIG. 22 illustrates an example of syntax of an AIT binding descriptor described in a second descriptor of an MH-AIT according to Embodiment 6 of the invention.

FIG. 23 illustrates an example of a data structure of a content transport unit according to Embodiment 7 of the invention.

FIG. 24 illustrates an example of syntax of an AIT binding descriptor described in a first descriptor of each MPT according to Embodiment 7 of the invention.

FIG. 25 illustrates an example of syntax of “MMT_general_location_info( )” described in the AIT binding descriptor according to Embodiment 7 of the invention.

FIG. 26 illustrates an example of syntax of an AIT binding descriptor described in a first descriptor of a certain MPT according to Embodiment 8 of the invention.

### DESCRIPTION OF EMBODIMENTS

### [Outline of Invention]

The invention provides a mechanism in which when a multiple program broadcasting content is reproduced, an application corresponding to the program being reproduced is activated. The multiple program broadcasting is simultaneous broadcasting of a plurality of programs (main channel/sub-channel) by one channel (by one broadcasting company). In the multiple program broadcasting, a main channel and a sub-channel included in one channel are referred to as a multichannel.

In the invention, MMT (MPEG Media Transport) is adopted as the transport standard of a program (content). The MMT is a media transport method used on the Internet Protocol (IP), and is a method enabling media transport in various transport paths. Specifically, in the MMT, by designating a packet ID, an IP address, or a URL by control information, it is possible to refer, through different networks, to components, such as video, audio, and data, which form a program. In the invention, the 8K (or 4K) broadcasting realized by the MMT is assumed.

### Embodiment 1

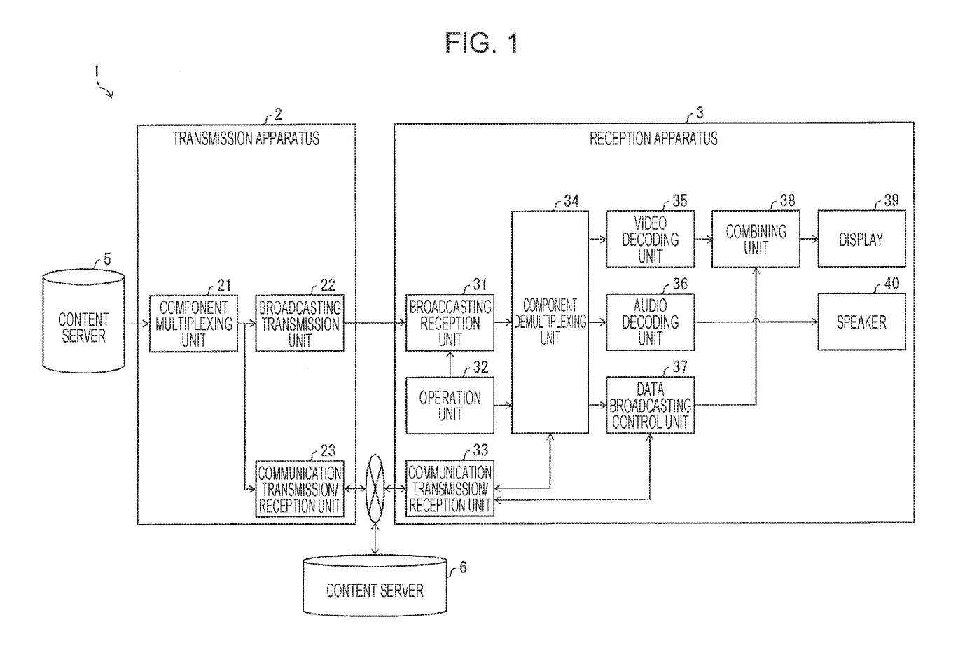

An embodiment (Embodiment 1) of the invention will be described as follows with reference to FIGS. 1 to 13.

### (Data Structure)

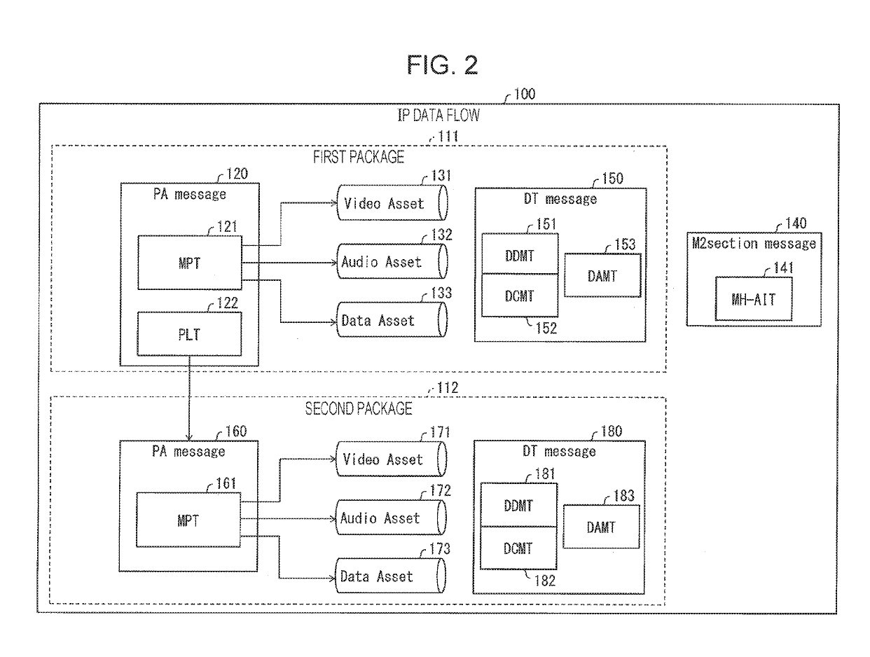

First, a data structure according to the present embodiment will be described with reference to FIG. 2. FIG. 2 illustrates an example of a data structure of a content transport unit according to Embodiment 1. The data structure illustrated in FIG. 2 is a data structure of an IP data flow of one channel including two multichannels.

An IP data flow 100 illustrated in FIG. 2 is a content transport unit according the present embodiment. As illustrated in FIG. 2, the IP data flow 100 is constituted by a first package 111, a second package 112, and an M2 section message 140. In the MMT, a unit of a content (program) is defined as a package, and the package and a multiple program service (multichannel) are associated with each other one to one. That is, each of the first package 111 and the second package 112 corresponds to one multichannel. In the present embodiment, the first package 111 corresponds to a multichannel ch101 and the second package 112 corresponds to a multichannel ch102.

The first package 111 includes a PA (Package Access) message 120, a video asset 131, an audio asset 132, a data asset 133, and a DT (Data Transfer) message 150. The second package 112 includes a PA message 160, a video asset 171, an audio asset 172, a data asset 173, and a DT message 180.

### (Asset)

In the MMT, a component such as video or audio is defined as an asset. That is, the video asset 131 and the video asset 171 are video components, the audio asset 132 and the audio asset 172 are audio components, and the data asset 133 and the data asset 173 are data broadcasting components.

### (PA Message)

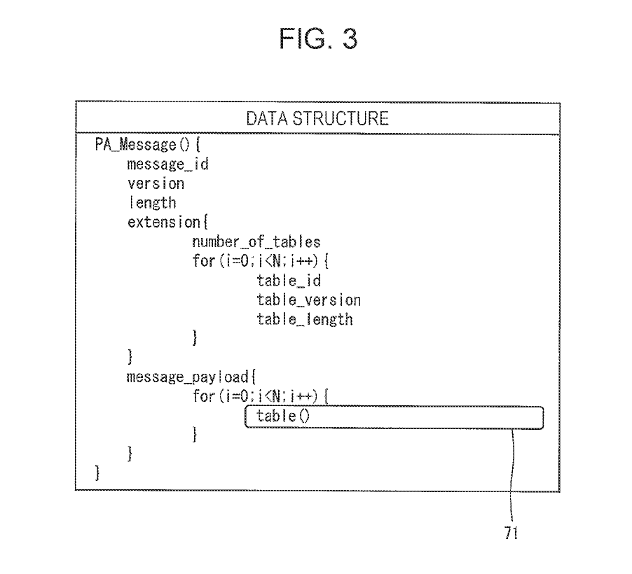

Each of the PA message 120 and the PA message 160 is a kind of control information, and is control information indicating, for example, a configuration (asset described later) of a content included in a package. In the MMT, a message includes a table having an element and an attribute which indicate specific information and the table includes a descriptor which indicates more detailed information. Specifically, the PA message 120 includes an MPT (MMT Package Table) 121 and a PLT (Package List Table) 122. The PA message 160 includes an MPT 161. FIG. 3 illustrates an example of syntax of the PA message 120 and the PA message 160. Tables such as the MPT 121, the MPT 161, and the PLT 122 are described in “table( )” 71 of the syntax illustrated in FIG. 3.

### (MPT)

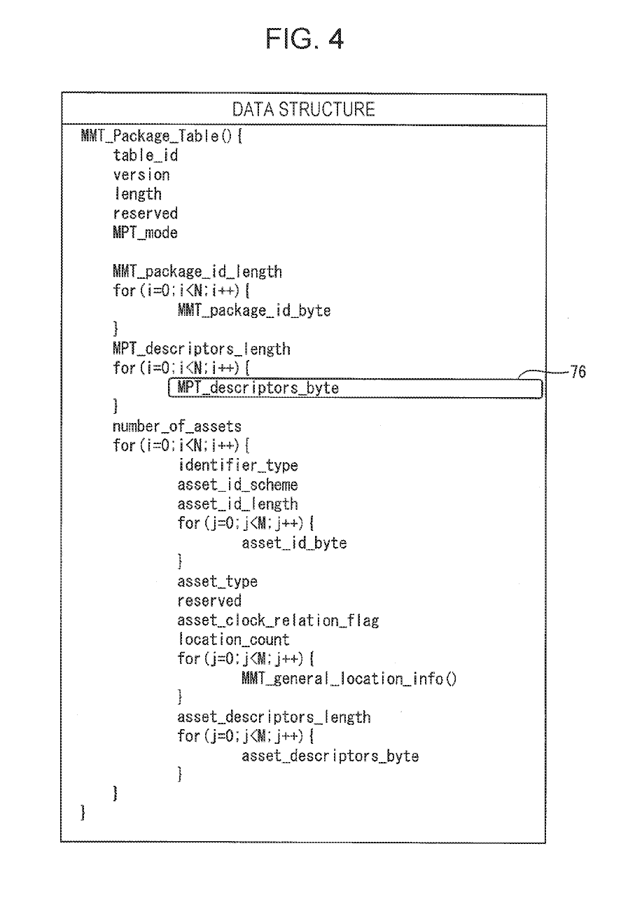

The MPT 121 and the MPT 161 indicate information forming a package, such as a list of an asset, a packet ID specifying an MMT packet in which the asset is included, and a position of an IP data flow. In other words, the MPT 121 and the MPT 161 are package configuration management information for managing the configuration of the package. Thus, by analyzing the MPT 121 and the MPT 161, an asset forming the package is able to be specified. FIG. 4 illustrates an example of syntax of the MPT 121 and the MPT 161.

### (PLT)

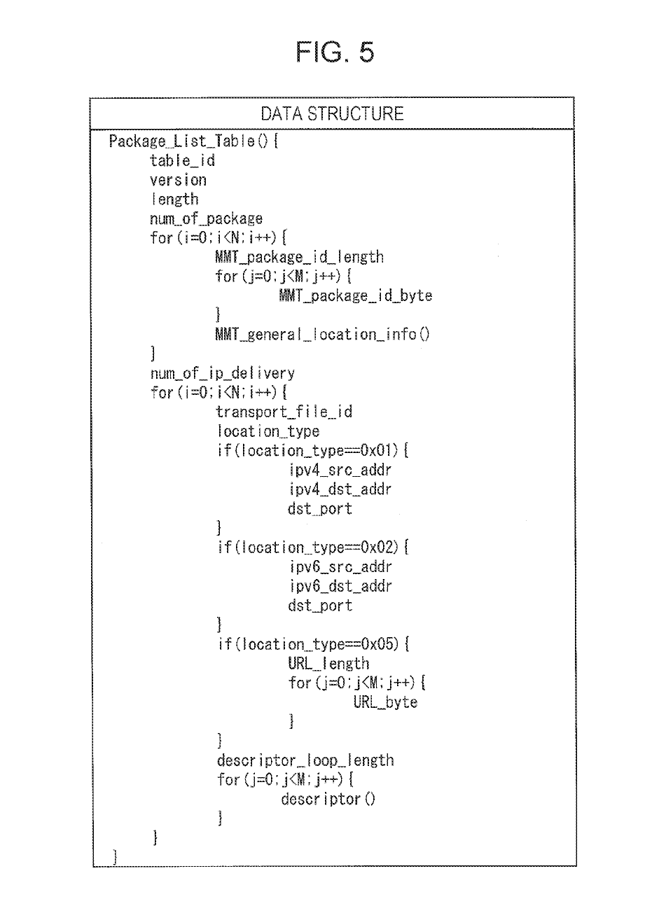

The PLT 122 indicates a list of the other package (second package 112) included in the IP data flow 100. More specifically, the PLT 122 indicates a list of a PA message included in the other package. Thus, by analyzing the PLT 122, an MPT of the PA message included in the other package is able to be specified and an asset forming the other package is able to be specified. FIG. 5 illustrates an example of syntax of the PLT 122.

### (DT Message)

Each of the DT message 150 and the DT message 180 is a kind of control information (control information of data broadcasting) and is a message related to data broadcasting. The DT message 150 includes a DDMT (data directory management table) 151, a DCMT (data content management table) 152, and a DAMT (data asset management table) 153, and the DT message 180 includes a DDMT 181, a DCMT 182, and a DAMT 183.

Each of the DDMT 151 and the DDMT 181 is a table for managing configurations of a file and a directory related to data broadcasting. Each of the DCMT 152 and the DCMT 182 is a table for controlling display processing of a data broadcasting content in a receiver. Each of the DAMT 153 and the DAMT 183 is a table for managing a data asset.

### (M2 Section Message)

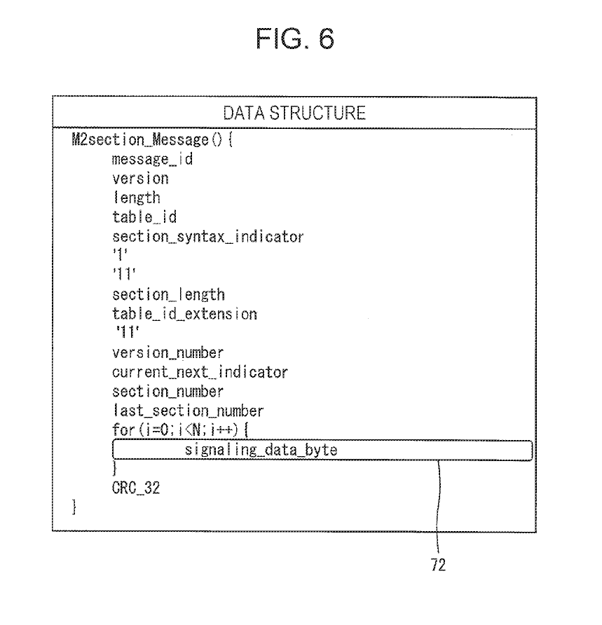

The M2 section message 140 is a kind of control information and is information used for transporting a section extended form of MPEG-2 Systems. In the present embodiment, the M2 section message 140 includes an MH-AIT 141. FIG. 6 illustrates an example of syntax of the M2 section message 140. The MH-AIT 141 is arranged in “signaling_data_byte” 72 of the syntax illustrated in FIG. 6.

### (MH-AIT)

The MH-AIT 141 is an AIT (Application Information Table) for the MMT. The MH-AIT 141 is application control information for notifying a reception apparatus of an existence of a broadcasting managed application in cooperation with a broadcasting service and instructing the reception apparatus to perform control therefor. The broadcasting managed application is software developed and operated for individual services in order to embody a service provided by a content transmission system described later, and is authenticated by a broadcasting company (or a business body entrusted by the broadcasting company) among software executed on the reception apparatus. The broadcasting managed application is simply referred to as an application below.

The broadcasting company may transmit the application to the reception apparatus by including the application in data broadcasting transmitted through a broadcast wave from a broadcasting station, may transmit the application to the reception apparatus by including the application in data broadcasting transmitted through a communication line from a broadcasting station, or may transmit the application to the reception apparatus through a communication line from a server that is managed by the business body entrusted by the broadcasting company. More details thereof will be later described.

Specifically, the MH-AIT 141 includes an application identifier (application_identifier), an MH-application descriptor (MH-Application_Descriptor), an MH-simple application location descriptor (MH-Simple_Application_Location_Descriptor), and the like. The application identifier is application identification information for uniquely identifying the application. The MH-application descriptor is application related information in which information related to control of the application, such as an application profile indicating a function of a reception apparatus (reception apparatus capable of executing the application) requested by the application, is described. In other words, the MH-application descriptor is information by which information for controlling the application is able to be described. The MH-simple application location descriptor is application acquisition destination information for specifying an acquisition destination of the application.

In the present embodiment, the MH-AIT 141 further includes package identification information (multichannel identification information for identifying a multichannel) for identifying each package in addition to the aforementioned information. Specifically, in the present embodiment, the application identifier has the package identification information.

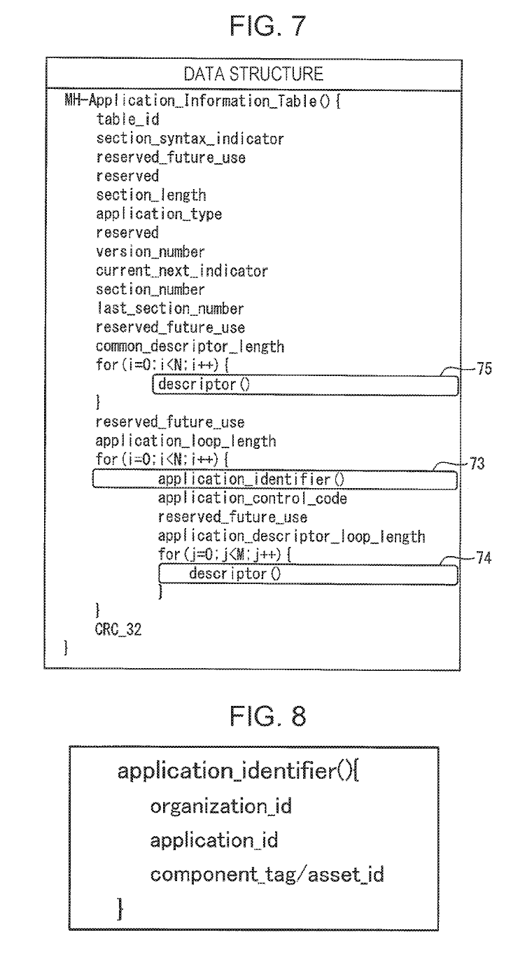

FIG. 7 illustrates an example of syntax of the MH-AIT 141. As described above, the package identification information is described in an application identifier 73 in the present embodiment. The MH-application descriptor (MH-Application_Descriptor) and the MH-simple application location descriptor (MH-Simple_Application_Location_Descriptor) are arranged in “descriptor( )” 74 of the syntax illustrated in FIG. 7. Note that, each application is provided with the MH-application descriptor and the MH-simple application location descriptor without exception.

FIG. 8 illustrates an example of description of the application identifier according to the present embodiment. As illustrated in FIG. 8, the application identifier has “organization_id”, “application_id”, and “component_tag/asset_id”. The “organization_id” indicates an organization (for example, a broadcasting company) that has created the application and is organization identification information for uniquely identifying the organization. The “application_id” is in-organization application identification information for uniquely identifying the application in the organization indicated by the “organization_id”. The application is able to be uniquely identified by the “organization_id” and the “application_id”. That is, the “organization_id” and the “application_id” are the application identification information. The “component_tag/asset_id” is the package identification information. The “component_tag” is component identification information for identifying a component. The “asset_id” is asset identification information for identifying an asset. That is, in the example illustrated in FIG. 8, the package identification information is the aforementioned component identification information or the aforementioned asset identification information. When being able to specify any component (or asset) included in a package, a reception apparatus 3 is able to specify the package, that is, a multichannel.

In this manner, the component identification information or the asset identification information is described in the application identifier. That is, the application identification information and the package identification information are associated with each other in the application identifier. Thus, when a component (asset) forming a program of a multichannel selected by a user is reproduced, the reception apparatus is able to activate the application corresponding to the component (asset) by referring to the application identifier.

That is, the application identifier according to the present embodiment is application specification information indicating an application corresponding to each package. In other words, the application identifier according to the present embodiment is application specification information for defining a relation between a multichannel (multiple program content) and an application.

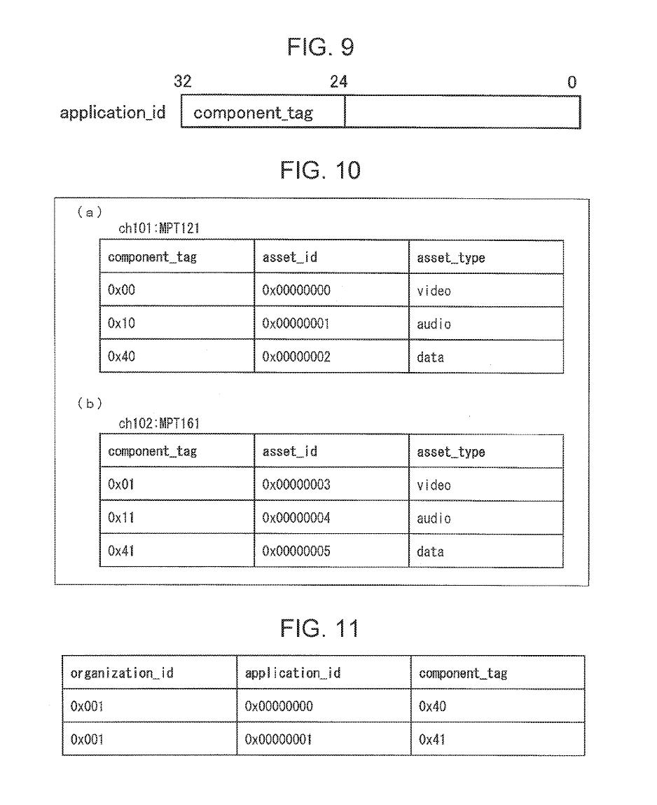

Next, FIG. 9 illustrates another example of description of the application identifier according to the present embodiment. As illustrated in FIG. 9, the “component_tag” may be described in eight higher-order bits of the “application_id” which has 32 bits. That is, the package identification information (component identification information or asset identification information) may be described in n higher-order bits or n lower-order bits of the in-organization application identification information.

Note that, the package identification information is not limited to the component identification information or the asset identification information and may be any information such as “service_id” or “MMT_package_id” as long as being information with which a package corresponding to an application is able to be identified. The “service_id” is service identification information for uniquely identifying a service. The “MMT_package_id” is MMT package identification information for uniquely identifying an MMT package.

### (Outline of Content Transmission System)

Next, the content transmission system according to the present embodiment will be described with reference to FIG. 1. FIG. 1 is a block diagram illustrating an example of a configuration of a content transmission system 1 according to Embodiment 1 and a main portion of a transmission apparatus 2 and the reception apparatus 3 included in the system.

As illustrated in FIG. 1, the content transmission system 1 includes the transmission apparatus 2, the reception apparatus 3, a content server 5, and a content server 6.

The transmission apparatus 2 is an apparatus that transmits a multiple program content in which a plurality of packages are allocated to one channel and is an apparatus that is managed by a broadcasting company or the like. The reception apparatus 3 is an apparatus that receives and reproduces a multiple program content in which a plurality of packages are allocated to one channel. Examples of the reception apparatus 3 include a television receiver, a mobile phone (smartphone), a tablet terminal, a PC, a portable game machine, and the like. The transmission apparatus 2 and the reception apparatus 3 are connected through the Internet. The transmission apparatus 2 is able to transmit a content and various other types of data to the reception apparatus 3 through the broadcast wave and the Internet.

The content server 5 is a server in which the content transmitted by the transmission apparatus 2 is stored. Though the content server 5 is separated from the transmission apparatus 2 in the example illustrated in FIG. 1, the transmission apparatus 2 may include the content server 5.

The content server 6 is a server that is managed by a company managing the transmission apparatus 2 or a server that is managed by a company (for example, a company entrusted by a broadcasting company managing the transmission apparatus 2) different from the company managing the transmission apparatus 2. The reception apparatus 3 is able to acquire a content and various other types of data not only from the transmission apparatus 2 but also from the content server 6 through the Internet.

The content transmission system 1 includes one transmission apparatus 2, one reception apparatus 3, one content server 5, and one content server 6 in the example illustrated in FIG. 1, but there is no limitation thereto. The content transmission system 1 may include a plurality of transmission apparatuses 2, a plurality of reception apparatuses 3, a plurality of content servers 5, and a plurality of content servers 6.

The configuration of the transmission apparatus 2 and the reception apparatus 3 forming the content transmission system 1 will be described below.

### (Configuration of Transmission Apparatus)

As illustrated in FIG. 1, the transmission apparatus 2 includes a component multiplexing unit (a generation unit, a transmission unit) 21, a broadcasting transmission unit 22, and a communication transmission/reception unit 23.

The component multiplexing unit 21 packetizes components such as video, audio, and data broadcasting, and multiplexes the resultant into one stream for transmission to the reception apparatus 3.

Specifically, the component multiplexing unit 21 acquires a content from the content server 5, and generates control information (such as the PA message, the M2 section message, or the DT message described above) of the acquired content. The component multiplexing unit 21 packetizes the generated control information and the components, such as video, audio, and data broadcasting, which form the acquired content, and multiplexes the resultant into one stream. The component multiplexing unit 21 transmits the generated stream to the reception apparatus 3 through the broadcasting transmission unit 22 or the communication transmission/reception unit 23.

In other words, the component multiplexing unit 21 generates application specification information (MH-AIT 141) indicating an application corresponding to each package. The component multiplexing unit 21 transmits a plurality of packages (contents of a multichannels) and the generated application specification information.

Then, the MPT generated by the component multiplexing unit 21 will be described with reference to FIG. 10. FIG. 10 illustrates an example of the MPT generated by the component multiplexing unit 21, in which FIG. 10(a) illustrates the MPT 121 and FIG. 10(b) illustrates the MPT 161.

As illustrated in FIG. 10, each of the MPT 121 and the MPT 161 includes “component_tag” as component identification information, “asset_id” as asset identification information, and “asset_type” as asset type information indicating a type of an asset.

Specifically, as illustrated in FIG. 2, the assets included in the first package 111 are the video asset 131, the audio asset 132, and the data asset 133. Thus, the component multiplexing unit 21 creates an asset list, in which the assets included in the first package 111 are listed, as the MPT 121 as illustrated in FIG. 10(a). That is, “asset_id=0x00000000(component_tag=0x00)” is the video asset 131, “asset_id=0x00000001(component_tag=0x10)” is the audio asset 132, and “asset_id=0x00000002(component_tag=0x40)” is the data asset 133. Similarly, the assets included in the second package 112 are the video asset 171, the audio asset 172, and the data asset 173. Thus, the component multiplexing unit 21 creates an asset list, in which the assets included in the second package 112 are listed, as the MPT 161 as illustrated in FIG. 10(b).

Note that, the component multiplexing unit 21 may transmit the generated stream to the reception apparatus 3 through the broadcasting transmission unit 22 and the communication transmission/reception unit 23.

The component multiplexing unit 21 may generate a plurality of streams (IP data flows) from the components, such as video, audio, and data broadcasting, which form the content, and the control information of the content, transmit a part of the streams to the reception apparatus 3 through the broadcasting transmission unit 22, and transmit the other streams to the reception apparatus 3 through the communication transmission/reception unit 23. For example, the component multiplexing unit 21 may multiplex the components, such as video and audio, which form the content, and the control information of the content into a first stream, multiplex the data broadcasting forming the content into a second stream, transmit the first stream to the reception apparatus 3 through the broadcasting transmission unit 22, and transmit the second stream to the reception apparatus 3 through the communication transmission/reception unit 23.

The broadcasting transmission unit 22 transmits data (such as a content) through the broadcast wave.

The communication transmission/reception unit 23 communicates with the reception apparatus 3 or other apparatuses such as the content server 6 through wireless communication means or wired communication means to exchange data.

### (Configuration of Reception Apparatus)

As illustrated in FIG. 1, the transmission apparatus 2 includes a broadcasting reception unit 31, an operation unit (input unit) 32, a communication transmission/reception unit 33, a component demultiplexing unit (reception unit) 34, a video decoding unit 35, an audio decoding unit (reproduction unit) 36, a data broadcasting control unit (control unit) 37, a combining unit (reproduction unit) 38, a display 39, and a speaker 40.

The operation unit 32 is used by a user to input an operation signal to the reception apparatus 3 and operate the reception apparatus 3. The operation unit 32 may be constituted by, for example, an input device such as a keyboard, a mouse, a keypad, or operation buttons. The operation unit 32 may be a touch panel in which the operation unit 32 and the display 39 are integrated. The operation unit 32 may be a remote control device, such as a remote controller, which is separate from the reception apparatus 3.

The operation unit 32 generates, in accordance with a channel operation by the user, a selected channel signal (selection instruction) indicating a channel (multichannel) selected by the user. The operation unit 32 outputs the selected channel signal, which is generated, to the broadcasting reception unit 31. When the user selects a multichannel, however, the operation unit 32 outputs the selected channel signal to the broadcasting reception unit 31 and the component demultiplexing unit 34.

The broadcasting reception unit 31 receives data through the broadcast wave. The broadcasting reception unit 31 is, for example, a broadcasting reception tuner. Upon reception of the selected channel signal from the operation unit 32, the broadcasting reception unit 31 performs tuning to a frequency of the channel indicated by the selected channel signal received and receives a stream of the channel.

The communication transmission/reception unit 33 communicates with the transmission apparatus 2 or other apparatuses such as the content server 6 through wireless communication means or wired communication means to exchange data.

The component demultiplexing unit 34 demultiplexes the stream received through the broadcasting reception unit 31, and outputs a demultiplexed video component to the video decoding unit 35, a demultiplexed audio component to the audio decoding unit 36, and a demultiplexed data broadcasting component and application control information to the data broadcasting control unit 37 on the basis of the control information.

Specifically, when the component demultiplexing unit 34 receives the selected channel signal (when the broadcasting reception unit 31 receives a multiple program stream) from the operation unit 32, the component demultiplexing unit 34 demultiplexes the stream received through the broadcasting reception unit 31 and obtains the components and the control information. Then, by referring to the control information, the component demultiplexing unit 34 specifies a package corresponding to a multichannel indicated by the selected channel signal. On the basis of the control information, the component demultiplexing unit 34 outputs components forming the specified package to the video decoding unit 35, the audio decoding unit 36, and the data broadcasting control unit 37. The component demultiplexing unit 34 outputs, to the data broadcasting control unit 37, a DDMT, a DCMT, and a DAMT of a DT message included in the specified package, and the MH-AIT 141 included in the M2 section message 140.

The component demultiplexing unit 34 acquires a stream through the communication transmission/reception unit 33 in accordance with a user operation (an operation signal received from the operation unit 32), demultiplexes the acquired stream, and outputs a demultiplexed video component to the video decoding unit 35, a demultiplexed audio component to the audio decoding unit 36, and a demultiplexed data broadcasting component and application control information to the data broadcasting control unit 37 on the basis of the control information.

Note that, the component demultiplexing unit 34 may temporarily store the demultiplexed data broadcasting component in a storage unit (not illustrated).

In other words, the component demultiplexing unit 34 receives a plurality of packages (contents of multichannels) and application specification information indicating an application corresponding to each of the packages.

The video decoding unit 35 acquires a coded video component from the component demultiplexing unit 34 and decodes the coded video component. The video decoding unit 35 outputs the decoded video component to the combining unit 38.

The audio decoding unit 36 acquires a coded audio component from the component demultiplexing unit 34 and decodes the coded audio component. The audio decoding unit 36 outputs the decoded audio component to the speaker 40 to cause the speaker 40 to output audio.

The data broadcasting control unit 37 acquires the data broadcasting component, the control information of data broadcasting, and the application control information from the component demultiplexing unit 34, and controls acquisition, activation, and the like of an application on the basis of the acquired application control information.

When having acquired the MH-AIT 141 from the component demultiplexing unit 34, the data broadcasting control unit 37 creates an application list indicating a correspondence relation between the application and the data broadcasting component on the basis of the MH-AIT 141. Specifically, as illustrated in FIG. 11, the data broadcasting control unit 37 creates, for each of application identifiers of the MH-AIT 141, an application list indicating a correspondence relation between application identification information included in the application identifier and package identification information. In the example illustrated in FIG. 11, the application list is information in which component identification information is associated with application identification information formed by organization identification information and in-organization application identification information for each of applications.

The data broadcasting control unit 37 then specifies an application corresponding to the data broadcasting component acquired from the component demultiplexing unit 34 by referring to the data broadcasting control information and the application list. The data broadcasting control unit 37 acquires the specified application by referring to the application control information. The data broadcasting control unit 37 activates the acquired application on the basis of the application control information.

Note that, after activating the application, the data broadcasting control unit 37 draws an image of the application, which is to be displayed on the display 39. The data broadcasting control unit 37 outputs the drawn application image to the combining unit 38.

On the basis of the application control information, the data broadcasting control unit 37 acquires the application with any of the following three routes. First, the data broadcasting control unit 37 acquires the application from the data broadcasting component acquired from the component demultiplexing unit 34. Second, the data broadcasting control unit 37 acquires the application from the external content server 6 or the like through the communication transmission/reception unit 33. Third, the data broadcasting control unit 37 acquires the application both from the data broadcasting component acquired from the component demultiplexing unit 34 and from the external content server 6 or the like through the communication transmission/reception unit 33.

In other words, the data broadcasting control unit 37 activates the application corresponding to the content being reproduced, by referring to the application specification information received by the component demultiplexing unit 34.

The combining unit 38 acquires the video component from the video decoding unit 35 and the application image or the like from the data broadcasting control unit 37 and generates a display image to be displayed on the display 39. The combining unit 38 outputs the generated display image to the display 39 and displays the display image on the display 39.

In this case, it can be said that the combining unit 38 and the audio decoding unit 36 serve as a reproduction unit that reproduces video and audio. The combining unit 38 and the audio decoding unit 36 reproduce, among packages received by the component demultiplexing unit 34, a package corresponding to the multichannel indicated by the selected channel signal received by the operation unit 32.

The display 39 is a display unit on which an image is displayed in accordance with an instruction of the combining unit 38. The display 39 is only required to be one on which an image is displayed in accordance with an instruction of the combining unit 38, and an LCD (liquid crystal display), an organic EL display, a plasma display, or the like is able to be applied, for example.

The speaker 40 receives audio data, which is an electric signal, from the audio decoding unit 36, converts the received audio data into audio, and outputs the audio to the outside of the reception apparatus 3.

### (Processing of Transmission Apparatus)

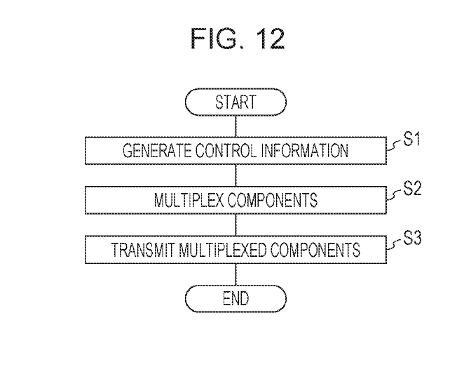

Next, content transmission processing of the transmission apparatus 2 will be described with reference to FIG. 12. FIG. 12 is a flowchart illustrating an example of the content transmission processing of the transmission apparatus 2. FIG. 12 indicates an example in which the transmission apparatus 2 transmits a content with the data structure illustrated in FIG. 2 to the reception apparatus 3 through the broadcast wave.

As illustrated in FIG. 12, the component multiplexing unit 21 acquires a content from the content server 5 and generates control information of the acquired content (S1: generation step). The component multiplexing unit 21 packetizes the generated control information and components, such as video, audio, and data broadcasting, which form the acquired content, and multiplexes the resultant into one stream (S2). The component multiplexing unit 21 transmits the generated stream to the reception apparatus 3 through the broadcasting transmission unit 22 (S3: transmission step).

### (Processing of Reception Apparatus)

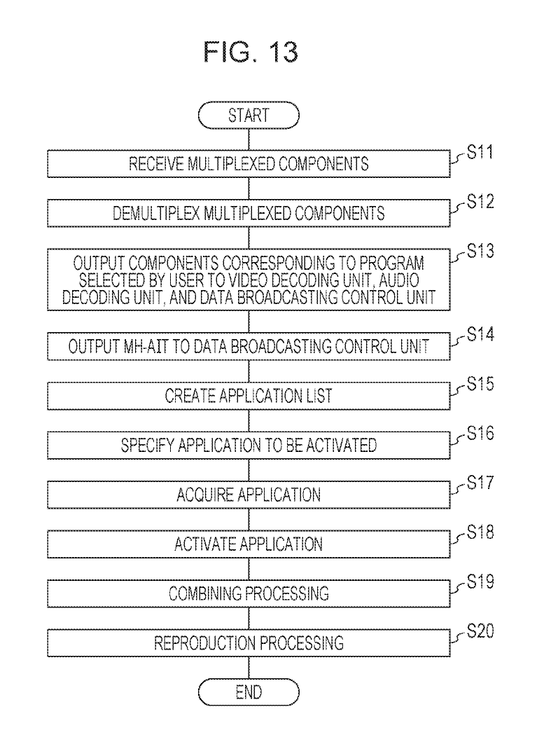

Next, content reception processing of the reception apparatus 3 will be described with reference to FIG. 13. FIG. 13 is a flowchart illustrating an example of the content reception processing of the reception apparatus 3. FIG. 13 indicates an example in which the reception apparatus 3 receives a content with the data structure illustrated in FIG. 2 through the broadcast wave. It is assumed that a user of the reception apparatus 3 selects the multichannel ch101.

As illustrated in FIG. 13, first, when the user inputs a selected channel signal by operating the operation unit 32, the broadcasting reception unit 31 receives the selected channel signal from the operation unit 32, performs tuning to a frequency of a channel indicated by the selected channel signal which is received, and receives a stream (multiplexed components: the IP data flow 100 illustrated in FIG. 2) of the channel (S11).

The component demultiplexing unit 34 receives the stream through the broadcasting reception unit 31, demultiplexes the received stream (S12: reception step), and obtains the components and control information. The component demultiplexing unit 34 receives the selected channel signal from the operation unit 32, and refers to the control information (MPT) to specify the first package 111 as a package corresponding to the multichannel ch101 indicated by the selected channel signal. The component demultiplexing unit 34 respectively outputs the components (the video asset 131, the audio asset 132, and the data asset 133) included in the specified first package to the video decoding unit 35, the audio decoding unit 36, and the data broadcasting control unit 37 (S13). The component demultiplexing unit 34 outputs the DDMT 151, the DCMT 152, and the DAMT 153 of the DT message 150 corresponding to the multichannel ch101 indicated by the selected channel signal, and the MH-AIT 141 to the data broadcasting control unit 37 (S14).

The data broadcasting control unit 37 acquires the MH-AIT 141 from the component demultiplexing unit 34, and creates an application list on the basis of the acquired MH-AIT 141 (S15). The data broadcasting control unit 37 refers to the DDMT 151, the DCMT 152, the DAMT 153, and the application list, and specifies an application corresponding to the data broadcasting component, which is acquired from the component demultiplexing unit 34 (S16). The data broadcasting control unit 37 acquires the specified application by referring to application control information (S17). The data broadcasting control unit 37 activates the acquired application on the basis of the application control information (S18: control step), draws an application image, and outputs the application image to the combining unit 38.

The video decoding unit 35 acquires a coded video component from the component demultiplexing unit 34, decodes the coded video component, and outputs the resultant to the combining unit 38. The combining unit 38 acquires the video component from the video decoding unit 35 and the application image or the like from the data broadcasting control unit 37, and generates a display image to be displayed on the display 39 (S19).

The combining unit 38 outputs the generated display image to the display unit 39 and displays the display image on the display 39 (S20: reproduction step). The audio decoding unit 36 decodes the audio component acquired from the component demultiplexing unit 34, and outputs the decoded audio component to the speaker 40 to cause the speaker 40 to output audio (S20: reproduction step).

### Embodiment 2

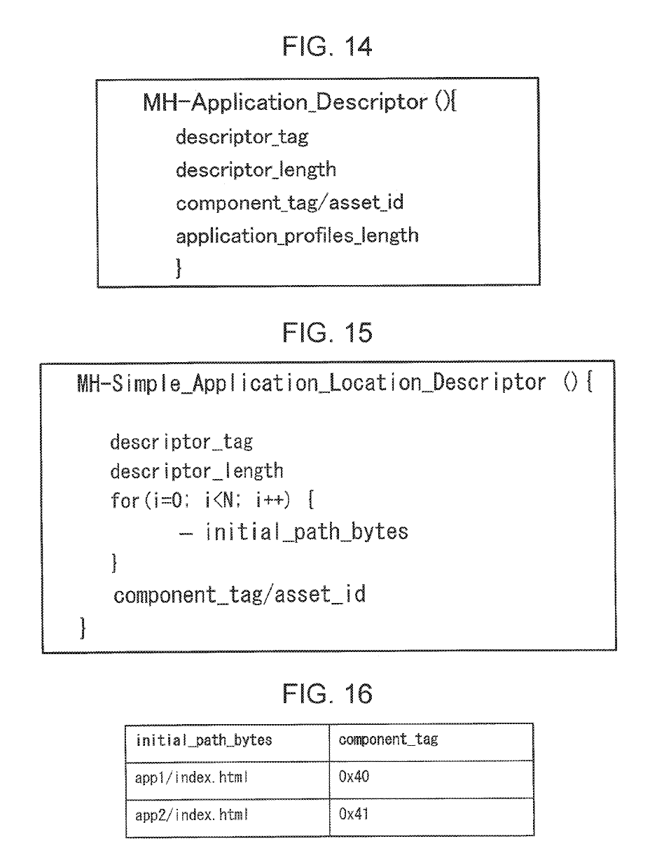

Another embodiment (Embodiment 2) of the invention will be described as follows with reference to FIG. 14. Note that, for convenience of description, members having the same functions as those of the members described in Embodiment 1 above will be denoted with the same reference signs and description thereof will be omitted.

In the present embodiment, differently from Embodiment 1, package identification information is described in an MH-application descriptor (MH-Application_Descriptor), and an application identifier (application_identifier) and the MH-application descriptor correspond to application specification information.

Specifically, an example of syntax of the MH-application descriptor (MH-Application_Descriptor) arranged in the “descriptor( )” 74 of the syntax illustrated in FIG. 7 is illustrated in FIG. 14. FIG. 14 illustrates an example of the syntax of the MH-application descriptor according to Embodiment 2.

As illustrated in FIG. 14, the MH-application descriptor includes “descriptor_tag”, “descriptor_length”, “component_tag/asset_id”, and “application_profiles_length”.

The “descriptor_tag” is information for identifying a descriptor and a value indicating the MH-application descriptor is set thereto. The “descriptor_length” indicates an entire byte length of the MH-application descriptor. The “component_tag/asset_id” is similar to that of Embodiment 1 and is the package identification information. The “application_profiles_length” indicates an entire byte length of application profile information included in a subsequent loop.

In this manner, since the package identification information is described in the MH-application descriptor and the MH-application descriptor is associated with the application identifier, the reception apparatus 3 is able to create the application list illustrated in FIG. 11 on the basis of the MH-AIT 141 in Embodiment 2 as well. Specifically, the data broadcasting control unit 37 creates the application list from the package identification information included in the MH-application descriptor, and the application identification information included in the application identifier corresponding to the MH-application descriptor.

### Embodiment 3

Another embodiment (Embodiment 3) of the invention will be described as follows with reference to FIGS. 15 and 16. Note that, for convenience of description, members having the same functions as those of the members described in Embodiment 1 above will be denoted with the same reference signs and description thereof will be omitted.

In the present embodiment, differently from Embodiment 1, package identification information is described in an MH-simple application location descriptor (MH-Simple_Application_Location_Descriptor), and an application identifier (application_identifier) and the MH-simple application location descriptor correspond to application specification information.

Specifically, an example of syntax of the MH-simple application location descriptor (MH-Simple_Application_Location_Descriptor) arranged in the “descriptor( )” 74 of the syntax illustrated in FIG. 7 is illustrated in FIG. 15. FIG. 15 illustrates an example of the syntax of the MH-simple application location descriptor according to Embodiment 3.

As illustrated in FIG. 15, the MH-application descriptor includes “descriptor_tag”, “descriptor_length”, “initial_path_bytes”, and “component_tag/asset_id”.

The “descriptor_tag” is information for identifying a descriptor and a value indicating the MH-simple application location descriptor is set thereto. The “descriptor_length” indicates an entire byte length of the MH-simple application location descriptor. In the “initial_path_bytes”, a character string indicating a URL of an entry document of a corresponding application is described. The “component_tag/asset_id” is similar to that of Embodiment 1 and is the package identification information.

Here, a transport protocol descriptor (not illustrated) is described in the MH-AIT 141. The transport protocol descriptor indicates designation of a transport protocol of broadcasting, communication, and the like, and location information of an application that depends on the transport protocol. Thus, each of the transport protocol descriptor and the MH-simple application location descriptor is application acquisition destination information for specifying an acquisition destination of the application.

Specifically, a URL base part and a URL extension part are described in the transport protocol descriptor, and an application URL is described in the “initial_path_bytes” of the MH-simple application location descriptor as described above. Thus, an application acquisition destination URL is “http://[URL base part]/[URL extension part]/[application URL]”. For example, in a case where the URL base part is “http://www.xbc.co.jp”, the URL extension part is “hybrid/appsA”, and the application URL is “appl/index.html”, the application acquisition destination URL is “http://www.xbc.co.jp/hybrid/appsA/appl/index.html”.

As a modified example of the package identification information in the MH-simple application location descriptor, the package identification information may be included in the “initial_path_bytes”. For example, the “initial_path_bytes” may be described as “[component_tag/asset_id]index.html”, “index[component_tag/asset_id].html”, or the like.

In this manner, since the package identification information is described in the MH-simple application location descriptor and the MH-simple application location descriptor is associated with the application identifier, the reception apparatus 3 is able to create the application list on the basis of the MH-AIT 141 in Embodiment 3 as well.

Here, an application list illustrated in FIG. 16 may be created instead of the application list illustrated in FIG. 11 in Embodiment 3. Specifically, as illustrated in FIG. 16, the data broadcasting control unit 37 may create the application list in which an application URL and component identification information (package identification information) are associated with each other for each application by referring to the MH-simple application location descriptor.

In this case, the data broadcasting control unit 37 refers to the DDMT 151, the DCMT 152, the DAMT 153, and the application list, acquires an application corresponding to a data broadcasting component, which is acquired from the component demultiplexing unit 34, and activates the acquired application. That is, in such a case, the data broadcasting control unit 37 is able to omit the processing at S16 of FIG. 13 in Embodiment 1.

### Embodiment 4

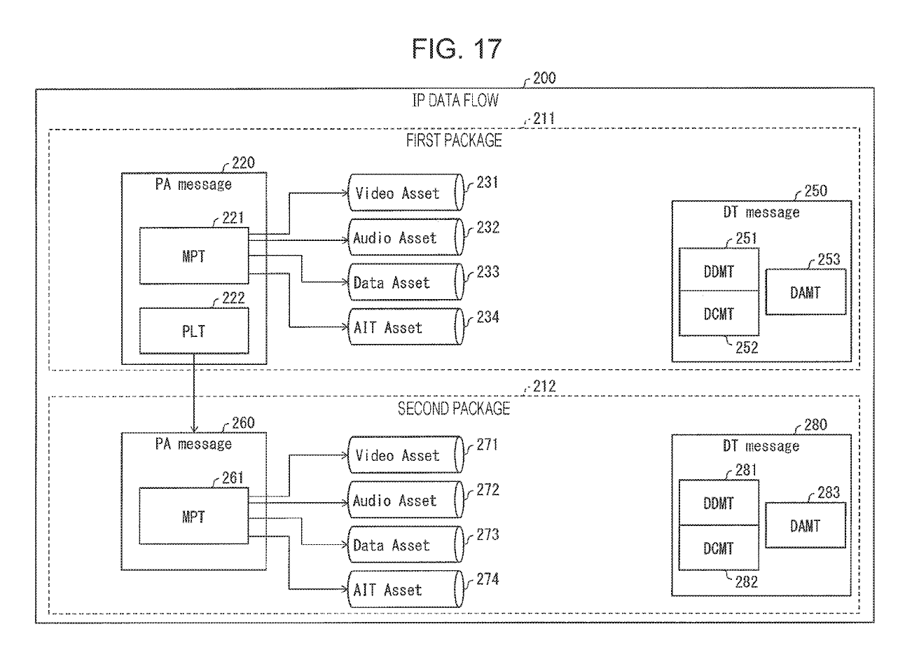

Another embodiment (Embodiment 4) of the invention will be described as follows with reference to FIGS. 17 to 20. Note that, for convenience of description, members having the same functions as those of the members described in Embodiment 1 above will be denoted with the same reference signs and description thereof will be omitted.

In the present embodiment, differently from Embodiment 1, application control information (AIT) is created for each of multichannels and the AIT is transmitted as one asset. A data structure according to the present embodiment will be described with reference to FIG. 17. FIG. 17 illustrates an example of a data structure of a content transport unit according to Embodiment 4. The data structure illustrated in FIG. 17 is a data structure of an IP data flow of one channel including two multichannels, similarly to the data structure illustrated in FIG. 2.

An IP data flow 200 illustrated in FIG. 17 is a transport unit of a content according the present embodiment. As illustrated in FIG. 17, the IP data flow 200 is constituted by a first package 211 and a second package 212. In the present embodiment, the first package 211 corresponds to the multichannel ch101 and the second package 212 corresponds to the multichannel ch102.

The first package 211 includes a PA message 220, a video asset 231, an audio asset 232, a data asset 233, an AIT asset 234, and a DT message 250. The second package 212 includes a PA message 260, a video asset 271, an audio asset 272, a data asset 273, an AIT asset 274, and a DT message 280.

In this manner, in the present embodiment, differently from Embodiment 1, each of packages includes an AIT asset. The MH-AIT 141 is not included in the IP data flow 200. That is, the AIT is associated with each of packages (each of programs (contents) of multichannels) in the present embodiment.

### (MPT)

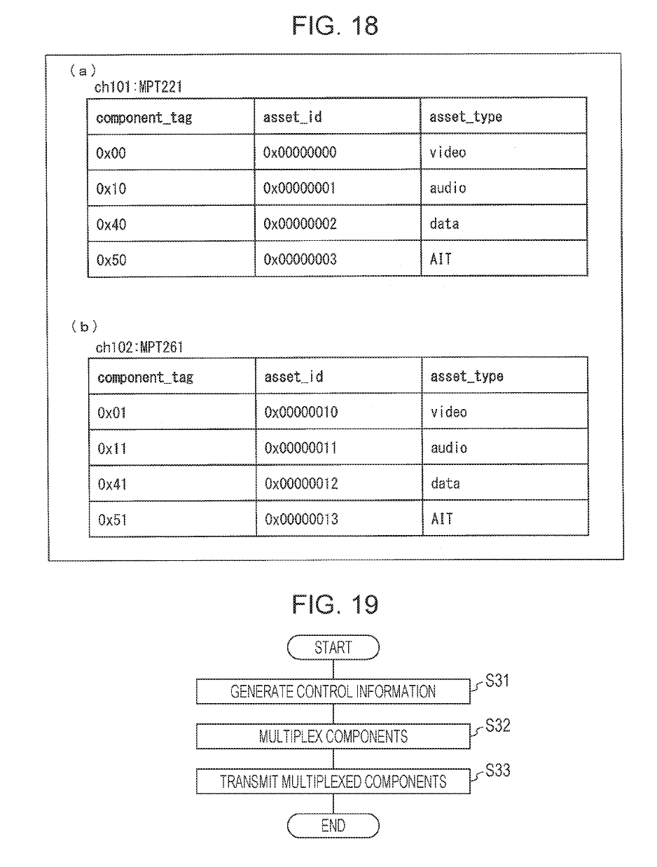

An example of an MPT generated by the component multiplexing unit 21 in the present embodiment is illustrated in FIG. 18. FIG. 18 illustrates an example of the MPT generated by the component multiplexing unit 21 in the present embodiment, in which FIG. 18(a) illustrates an MPT 221 and FIG. 18(b) illustrates an MPT 261.

As illustrated in FIG. 18, each of the MPT 221 and the MPT 261 includes “component_tag” as component identification information, “asset_id” as asset identification information, and “asset_type” as asset type information indicating a type of an asset.

Specifically, as illustrated in FIG. 17, the assets included in the first package 211 are the video asset 231, the audio asset 232, the data asset 233, and the AIT asset 234. Thus, the component multiplexing unit 21 creates an asset list, in which the assets included in the first package 211 are listed, as the MPT 221 as illustrated in FIG. 18(a). That is, “asset_id=0x00000000(component_tag=0x00)” is the video asset 231, “asset_id=0x00000001(component_tag=0x10)” is the audio asset 232, “asset_id=0x00000002(component_tag=0x40)” is the data asset 233, and “asset_id=0x00000003(component_tag=0x50)” is the AIT asset 234. Similarly, the assets included in the second package 212 are the video asset 271, the audio asset 272, the data asset 273, and the AIT asset 274. Thus, the component multiplexing unit 21 creates an asset list, in which the assets included in the second package 212 are listed, as the MPT 261 as illustrated in FIG. 18(b).

### (Processing of Transmission Apparatus)

Next, content transmission processing of the transmission apparatus 2 according to the present embodiment will be described with reference to FIG. 19. FIG. 19 is a flowchart illustrating an example of the content transmission processing of the transmission apparatus 2 according to Embodiment 4. FIG. 19 indicates an example in which the transmission apparatus 2 transmits a content with the data structure illustrated in FIG. 17 to the reception apparatus 3 through the broadcast wave.

As illustrated in FIG. 19, the component multiplexing unit 21 acquires a content from the content server 5 and generates control information of the acquired content (S31: generation step). Specifically, the component multiplexing unit 21 generates, for each of contents of a multichannel, an MPT associated with the content. The component multiplexing unit 21 packetizes the generated control information and components, such as video, audio, and data broadcasting, which form the acquired content, and multiplexes the resultant into one stream (S32). The component multiplexing unit 21 transmits the generated stream to the reception apparatus 3 through the broadcasting transmission unit 22 (S33: transmission step).

That is, the component multiplexing unit 21 according to the present embodiment is a generation unit that generates, for each of packages, application control information corresponding to the package and is a transmission unit that transmits plural pieces of application control information that are generated.

### (Processing of Reception Apparatus)

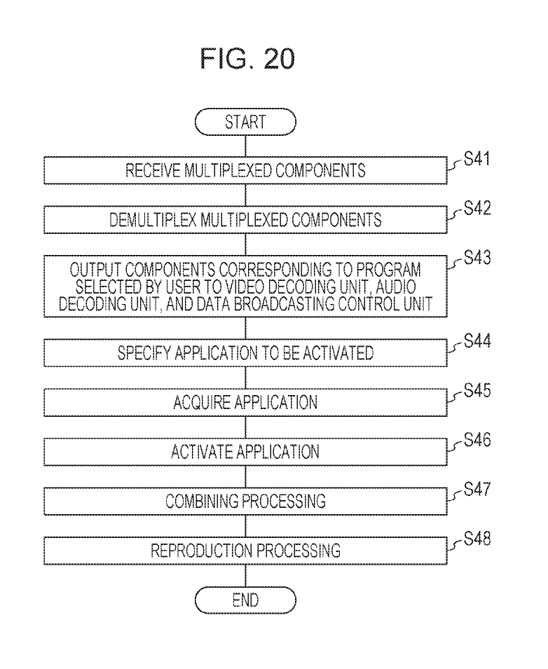

Next, content reception processing of the reception apparatus 3 according to the present embodiment will be described with reference to FIG. 20. FIG. 20 is a flowchart illustrating an example of the content reception processing of the reception apparatus 3 according to Embodiment 4. FIG. 20 indicates an example in which the reception apparatus 3 receives a content with the data structure illustrated in FIG. 17 through the broadcast wave. It is assumed that a user of the reception apparatus 3 selects the multichannel ch101.

As illustrated in FIG. 20, first, when the user operates the operation unit 32 to input a selected channel signal (input step), the broadcasting reception unit 31 receives the selected channel signal from the operation unit 32, performs tuning to a frequency of a channel indicated by the selected channel signal which is received, and receives a stream (multiplexed components: the IP data flow 200 illustrated in FIG. 17) of the channel (S41).

The component demultiplexing unit 34 receives the stream through the broadcasting reception unit 31, demultiplexes the received stream (S42: reception step), and obtains the components and control information. The component demultiplexing unit 34 receives the selected channel signal from the operation unit 32, and refers to the control information (MPT) to specify the first package 211 as a package corresponding to the multichannel ch101 indicated by the selected channel signal. The component demultiplexing unit 34 outputs the video asset 231 included in the specified first package 211 to the video decoding unit 35, outputs the audio asset 232 to the audio decoding unit 36, and outputs the DDMT 251, the DCMT 252, and the DAMT 253 of the DT message 250, the data asset 233, and the AIT asset 234 to the data broadcasting control unit 37 (S43).

The data broadcasting control unit 37 acquires the AIT asset 234 from the component demultiplexing unit 34, and specifies an application to be activated by referring to the acquired AIT asset 234 (S44). The data broadcasting control unit 37 acquires the specified application by referring to the AIT asset 234 (S45: control step). The data broadcasting control unit 37 activates the acquired application on the basis of the AIT asset 234 (S46: control step), draws an application image, and outputs the application image to the combining unit 38.

The video decoding unit 35 acquires a coded video component from the component demultiplexing unit 34, decodes the coded video component, and outputs the resultant to the combining unit 38. The combining unit 38 acquires the video component from the video decoding unit 35 and the application image or the like from the data broadcasting control unit 37 and generates a display image to be displayed on the display 39 (S47).

The combining unit 38 outputs the generated display image to the display 39 and displays the display image on the display 39 (S48: reproduction step). The audio decoding unit 36 decodes an audio component acquired from the component demultiplexing unit 34, and outputs the decoded audio component to the speaker 40 to cause the speaker 40 to output audio (S48: reproduction step).

That is, the component demultiplexing unit 34 according to the present embodiment is a reception unit that receives, for each of packages, application control information for controlling an application corresponding to the package. The data broadcasting control unit 37 according to the present embodiment is a control unit that refers to application control information corresponding to a reproduced package and activates an application corresponding to the package.

### Embodiment 5

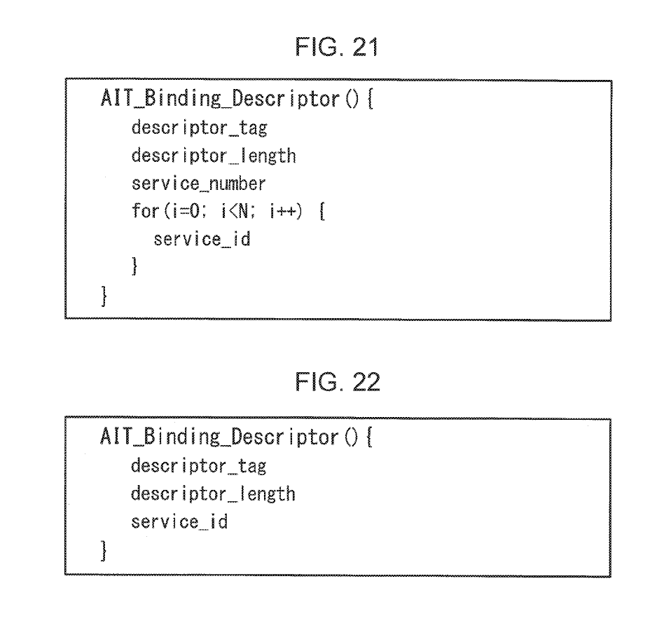

Another embodiment (Embodiment 5) of the invention will be described as follows with reference to FIG. 21. Note that, for convenience of description, members having the same functions as those of the members described in Embodiment 1 above will be denoted with the same reference signs and description thereof will be omitted.

In the present embodiment, differently from Embodiment 1, an AIT binding descriptor is arranged in a first descriptor of the MH-AIT 141 and package identification information is described in the AIT binding descriptor. A correspondence relation between the package identification information and application identification information is also defined in the AIT binding descriptor. That is, the AIT binding descriptor (and an application identifier) corresponds to application specification information in the present embodiment.

Specifically, an example of syntax of the AIT binding descriptor (AIT_Binding_Descriptor) arranged in “descriptor( )” 75 which is a first descriptor of the syntax illustrated in FIG. 7 is illustrated in FIG. 21. FIG. 21 illustrates an example of the syntax of the AIT binding descriptor according to Embodiment 5.

The “descriptor_tag” is information for identifying a descriptor and a value indicating the AIT binding descriptor is set thereto. The “descriptor_length” indicates an entire byte length of the AIT binding descriptor. The “service_number” indicates the number of services (packages) described in the AIT binding descriptor. The “service_id” is service identification information. In the present embodiment, the “service_id” has a similar function to that of the “component_tag/asset_id” of Embodiment 1 and corresponds to the package identification information. Pieces of the “service_id” with the number of packages described in the “service_number” are described in the AIT binding descriptor.

In the same order as order of describing pieces of application identification information in the application identifier described in the “descriptor( )” 74 which is a second descriptor of the MH-AIT 141, the pieces of service identification information “service_id” corresponding to the pieces of application identification information are described in the AIT binding descriptor. Note that, a method of defining the correspondence relation between the package identification information and the application identification information in the AIT binding descriptor is not limited thereto and may be any method.

In this manner, since the package identification information, and the correspondence relation between the package identification information and the application identifier are described in the AIT binding descriptor, the reception apparatus 3 is able to create the application list illustrated in FIG. 11 on the basis of the MH-AIT 141 in Embodiment 5 as well. Specifically, the data broadcasting control unit 37 creates the application list by referring to the AIT binding descriptor and the application identifier and associating the pieces of package identification information and the pieces of application identification information, which are described in the same order in the AIT binding descriptor and the application identifier. By referring to the application list, the reception apparatus 3 is able to specify, on the basis of the MH-AIT 141, an application to be activated when a package is reproduced in Embodiment 5 as well.

### Embodiment 6

Another embodiment (Embodiment 6) of the invention will be described as follows with reference to FIG. 22. Note that, for convenience of description, members having the same functions as those of the members described in Embodiment 1 above will be denoted with the same reference signs and description thereof will be omitted.

In the present embodiment, differently from Embodiment 1, an AIT binding descriptor is arranged in a second descriptor of the MH-AIT 141 and package identification information is described in the AIT binding descriptor. Since the second descriptor is arranged for each application identification information (application) in the MH-AIT 141, the application identification information described in an application identifier and the package identification information described in the AIT binding descriptor are associated with each other in the MH-AIT 141. That is, the AIT binding descriptor and the application identifier correspond to application specification information in the present embodiment.

Specifically, an example of syntax of the AIT binding descriptor (AIT_Binding_Descriptor) arranged in the “descriptor( )” 74 which is the second descriptor of the syntax illustrated in FIG. 7 is illustrated in FIG. 22. FIG. 22 illustrates an example of the syntax of the AIT binding descriptor according to Embodiment 6.

The “descriptor_tag” is information for identifying a descriptor and a value indicating the AIT binding descriptor is set thereto. The “descriptor_length” indicates an entire byte length of the AIT binding descriptor. The “service_id” is service identification information. In the present embodiment, the “service_id” has a similar function to that of the “component_tag/asset_id” of Embodiment 1 and corresponds to the package identification information.

In this manner, since the AIT binding descriptor including the package identification information is described for each application identification information in the MH-AIT 141, the reception apparatus 3 is able to create the application list illustrated in FIG. 11 on the basis of the MH-AIT 141 in Embodiment 6 as well. Specifically, the data broadcasting control unit 37 creates the application list by referring to the application identifier and the AIT binding descriptor and specifying the package identification information corresponding to the application identification information. By referring to the application list, the reception apparatus 3 is able to specify, on the basis of the MH-AIT 141, an application to be activated when a package is reproduced in Embodiment 6 as well.

### Embodiment 7

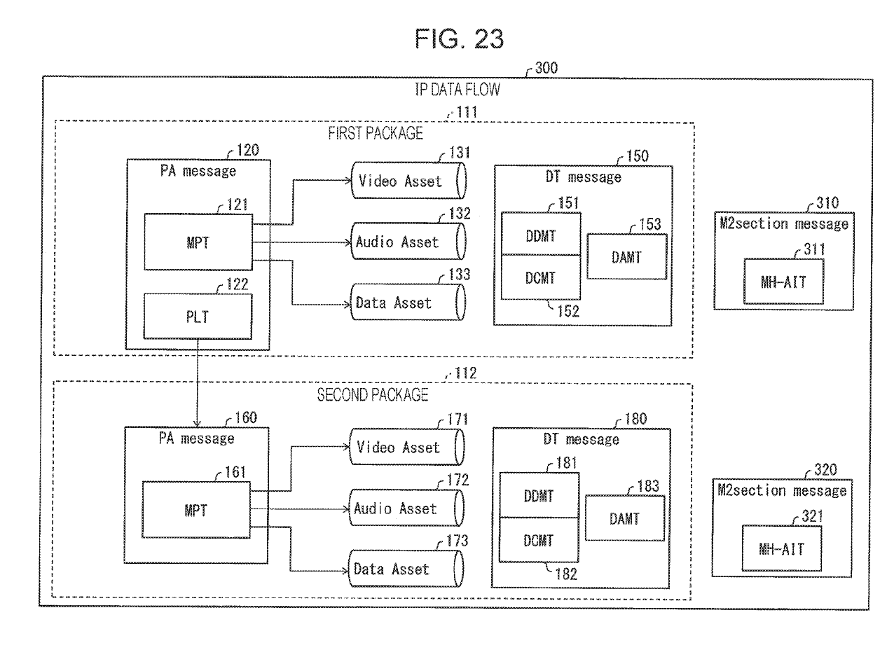

Another embodiment (Embodiment 7) of the invention will be described as follows with reference to FIGS. 23 to 25. Note that, for convenience of description, members having the same functions as those of the members described in Embodiment 1 above will be denoted with the same reference signs and description thereof will be omitted.

In the present embodiment, differently from Embodiment 1, an IP data flow has an M2 section message which includes MH-AITs with the same number as the number of packages included in the IP data flow. Moreover, in the present embodiment, an AIT binding descriptor is arranged in a first descriptor of an MPT included in each of the packages and information for specifying an MH-AIT corresponding to the package is described in the AIT binding descriptor. That is, the MPT and the MH-AIT are associated with each other one-to-one in the present embodiment. In the present embodiment, the AIT binding descriptor described in each of MPTs corresponds to application specification information.

Specifically, a data structure according to the present embodiment will be described with reference to FIG. 23. FIG. 23 illustrates an example of a data structure of a content transport unit according to Embodiment 7. The data structure illustrated in FIG. 23 is a data structure of an IP data flow of one channel including two multichannels, similarly to the data structure illustrated in FIG. 2.

As illustrated in FIG. 23, an IP data flow 300 has two M2 section messages 310 and 320 differently from Embodiment 1. The M2 section message 310 has an MH-AIT 311 and the M2 section message 320 has an MH-AIT 321. As described above, each of the M2 section messages (MH-AITs) corresponds to a package, and the M2 section message 310 corresponds to the first package 111 and the M2 section message 320 corresponds to the second package 112.

Note that, a data structure of the MH-AIT 311 and the MH-AIT 321 according to the present embodiment is basically the same as the data structure of the MH-AIT 141 according to Embodiment 1 illustrated in FIG. 7.

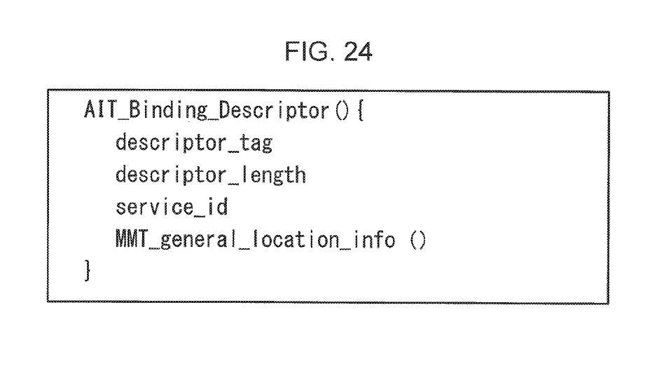

An example of syntax of an AIT binding descriptor (AIT_Binding_Descriptor) arranged in “MPT_descriptors_byte” 76 which is a first descriptor of the syntax illustrated in FIG. 4 is indicated in FIG. 24. FIG. 24 illustrates an example of the syntax of the AIT binding descriptor according to Embodiment 7.

The “descriptor_tag” is information for identifying a descriptor and a value indicating the AIT binding descriptor is set thereto. The “descriptor_length” indicates an entire byte length of the AIT binding descriptor. The “service_id” is service identification information. In the present embodiment, the “service_id” has a similar function to that of the “component_tag/asset_id” of Embodiment 1 and corresponds to package identification information. In the “MMT_general_location_info( )”, information for specifying an MMT packet in which an M2 section message for transporting an MH-AIT is included is described.

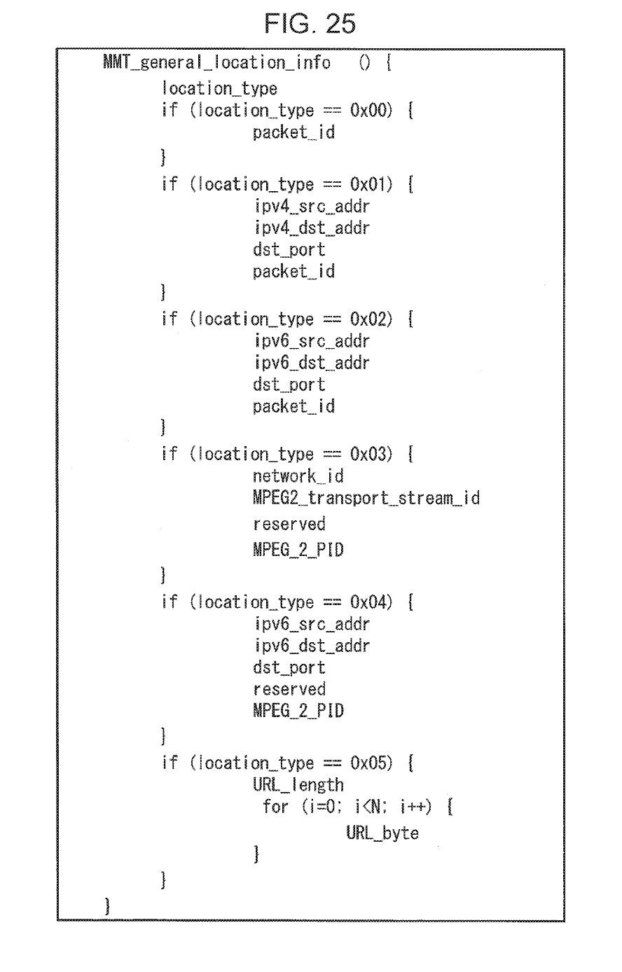

FIG. 25 illustrates an example of syntax of the “MMT_general_location_info( )”. Specifically, for example, in a case where the “location type” in the “MMT_general_location_info( )” of the AIT binding descriptor arranged in a first descriptor of the MPT 121 of the first package 111 is “0x00”, information that indicates a packet ID of an MMT in which the M2 section message 140 for transporting the MH-AIT 141 corresponding to the first package 111 is included is described in the “packet_id”. That is, the reception apparatus 3 is able to acquire the MH-AIT 141 linked to the first package (service) by referring to the packet ID.

Similarly, when specifying an application linked to the second package 112 included in the PLT 122, the MPT 161 corresponding to the second package 112 is acquired by referring to the PLT 122 and an MH-AIT 191 linked to the second package 112 is acquired on the basis of information of an AIT binding descriptor included in the first descriptor of the MPT 161, so that the application linked to the second package 112 is able to be specified.

In this manner, since an AIT binding descriptor is described in each of MPTs and information for specifying an MH-AIT corresponding to a package managed by the MPT is described in the AIT binding descriptor, the reception apparatus 3 is able to specify, on the basis of the MPT and the MH-AIT, an application to be activated when a package is reproduced in Embodiment 7 as well. Specifically, the data broadcasting control unit 37 specifies an MH-AIT corresponding to a package by referring to an AIT binding descriptor of an MPT, and specifies an application to be activated when a package is reproduced by referring to the specified MH-AIT.

### Embodiment 8

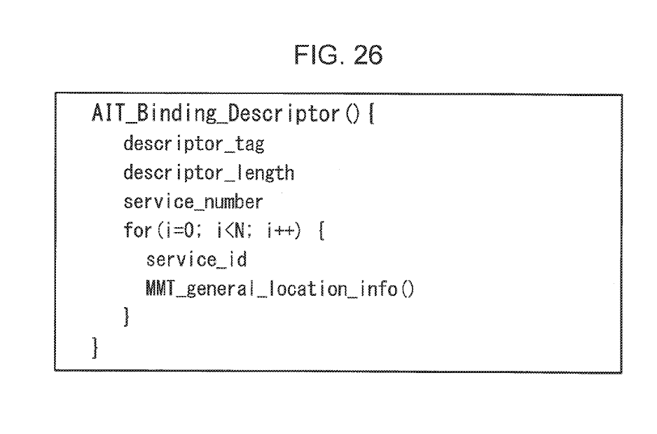

Another embodiment (Embodiment 8) of the invention will be described as follows with reference to FIG. 26. Note that, for convenience of description, members having the same functions as those of the members described in Embodiment 1 above will be denoted with the same reference signs and description thereof will be omitted.

In the present embodiment, differently from Embodiment 1, an IP data flow has an M2 section message which includes MH-AITs with the same number as the number of packages included in the IP data flow. Moreover, in the present embodiment, an AIT binding descriptor is arranged in a first descriptor of an MPT included in a certain package and a correspondence relation between each package and each MH-AIT is defined in the AIT binding descriptor. That is, in the present embodiment, an AIT binding descriptor described in a certain MPT corresponds to application specification information.

That is, in the present embodiment, differently from Embodiment 7, information of all MH-AITs corresponding to packages is described, that is, information indicating a correspondence relation between all the packages and MH-AITs (applications) is described in an AIT binding descriptor arranged in a certain MPT.

Note that, a data structure of an IP data flow according to the present embodiment is the same as the data structure of the IP data flow according to Embodiment 7 illustrated in FIG. 23. In the present embodiment, it is assumed that an AIT binding descriptor is arranged in the MPT 121 included in the first package. However, the AIT binding descriptor is not limited thereto and is only required to be arranged in an MPT of any package included in the IP data flow.

Specifically, an example of syntax of an AIT binding descriptor (AIT_Binding_Descriptor) arranged in the “MPT_descriptors_byte” 76 of the syntax illustrated in FIG. 4 is indicated in FIG. 26. FIG. 26 illustrates an example of the syntax of the AIT binding descriptor according to Embodiment 8.

The “descriptor_tag” is information for identifying a descriptor and a value indicating the AIT binding descriptor is set thereto. The “descriptor_length” indicates an entire byte length of the AIT binding descriptor. The “service_number” indicates the number of services (packages) described in the AIT binding descriptor. The “service_id” is service identification information. In the present embodiment, the “service_id” has a similar function to that of the “component_tag/asset_id” of Embodiment 1 and corresponds to package identification information. The “MMT_general_location_info( )” is similar to that of Embodiment 7 and information for specifying an MMT packet in which an M2 section message for transporting an MH-AIT is included is described therein. The “service_id” and the “MMT_general_location_info( )”, each of which has the same number as the number of packages described in the “service_number”, are described in the AIT binding descriptor.

In this manner, since the AIT binding descriptor is described in a certain MPT and information indicating a correspondence relation between each package and each MH-AIT is described in the AIT binding descriptor, the reception apparatus 3 is able to create the application list illustrated in FIG. 11 on the basis of the certain MPT and each MH-AIT in Embodiment 8 as well. Specifically, the data broadcasting control unit 37 creates the application list by specifying an MH-AIT corresponding to each package by referring to the AIT binding descriptor of the certain MPT and specifying an application corresponding to each package by referring to the specified MH-AIT. By referring to the application list, the reception apparatus 3 is able to specify, on the basis of the certain MPT and each MH-AIT, an application to be activated when a package is reproduced in Embodiment 8 as well.

### [Implementation Example by Software]

Control blocks (particularly, the component multiplexing unit 21) of the transmission apparatus 2 and control blocks (particularly, the component demultiplexing unit 34, the video decoding unit 35, the audio decoding unit 36, the data broadcasting control unit 37, and the combining unit 38) of the reception apparatus 3 may be implemented by a logical circuit (hardware) formed in an integrated circuit (IC chip) or the like, or may be implemented by software with use of a CPU (Central Processing Unit).

In the latter case, each of the transmission apparatus 2 and the reception apparatus 3 includes a CPU that executes a command of a program serving as software realizing each function, a ROM (Read Only Memory) or a storage device (each of which is referred to as a “recording medium”) in which the program and various data are recorded to be readable by a computer (or a CPU), a RAM (Random Access Memory) in which the program is developed, and the like. The object of the invention is achieved when the computer (or the CPU) reads the program from the recording medium for execution. As the recording medium, a “non-transitory tangible medium”, for example, such as a tape, a disc, a card, a semiconductor memory, or a programmable logical circuit is able to be used. The program may be supplied to the computer via any transmission medium (such as a communication network or a broadcast wave) that is able to transmit the program. Note that, the invention may be implemented also in a form of a data signal embedded in a carrier wave in which the program is provided by electronic transmission.

### [Additional Matter]

In order to solve the aforementioned problem, a reception apparatus according to an aspect of the invention is a reception apparatus that receives a multiple program content in which a plurality of packages are allocated to one channel and includes: a reception unit that receives application specification information indicating an application corresponding to each of the packages; a reproduction unit that reproduces one of the packages; and a control unit that activates an application corresponding to a package, which is being reproduced by the reproduction unit, by referring to the application specification information received by the reception unit.

In order to solve the aforementioned problem, a reception apparatus according to an aspect of the invention is a reception apparatus that receives a multiple program content in which a plurality of packages are allocated to one channel and includes: a reception unit that receives, for each of the packages, application control information for controlling an application corresponding to the package; a reproduction unit that reproduces one of the packages; and a control unit that refers to application control information corresponding to a package, which is being reproduced by the reproduction unit, to thereby activate an application corresponding to the package.

In order to solve the aforementioned problem, a transmission apparatus according to an aspect of the invention is a transmission apparatus that transmits a multiple program content, in which a plurality of packages are allocated to one channel, to a reception apparatus and includes: a generation unit that generates application specification information indicating an application corresponding to each of the packages; and a transmission unit that transmits the application specification information generated by the generation unit.

In order to solve the aforementioned problem, a transmission apparatus according to an aspect of the invention is a transmission apparatus that transmits a multiple program content, in which a plurality of packages are allocated to one channel, to a reception apparatus and includes: a generation unit that generates, for each of the packages, application control information corresponding to the package; and a transmission unit that transmits a plurality of pieces of application control information generated by the generation unit.

In order to solve the aforementioned problem, a method for controlling a reception apparatus according to an aspect of the invention is a method for controlling a reception apparatus that receives a multiple program content in which a plurality of packages are allocated to one channel. The method includes: a reception step of receiving application specification information indicating an application corresponding to each of the packages; a reproduction step of reproducing one of the packages; and a control step of activating an application corresponding to a package, which is being reproduced at the reproduction step, by referring to the application specification information received at the reception step.

In order to solve the aforementioned problem, a method for controlling a transmission apparatus according to an aspect of the invention is a method for controlling a transmission apparatus that transmits a multiple program content in which a plurality of packages are allocated to one channel. The method includes: a generation step of generating application specification information indicating an application corresponding to each of the packages; and a transmission step of transmitting the application specification information generated at the generation step.

### [Overview]

A reception apparatus according to an aspect 1 of the invention is a reception apparatus that receives a multiple program content in which a plurality of packages are allocated to one channel and includes: a reception unit (component demultiplexing unit 34) that receives application specification information indicating an application corresponding to each of the packages; a reproduction unit (combining unit 38, audio decoding unit 36) that reproduces one of the packages; and a control unit (data broadcasting control unit 37) that activates an application corresponding to a package, which is being reproduced by the reproduction unit, by referring to the application specification information received by the reception unit.

According to the aforementioned configuration, the control unit activates the application corresponding to the package, which is being reproduced by the reproduction unit, by referring to the application specification information. Thus, the reception apparatus is able to activate, for each of packages, that is, for each of multichannels (multiple program contents), an application corresponding to the multichannel.

The reception apparatus according to an aspect 2 of the invention may be configured so that in the aspect 1, the application specification information is information in which application identification information for identifying an application and package identification information for identifying the package are associated with each other.

The reception apparatus according to an aspect 3 of the invention may be configured so that in the aspect 1 or 2, the content is transmitted by MMT, and the application specification information is described in application control information for MMT.

The reception apparatus according to an aspect 4 of the invention may be configured so that in any of the aspects 1 to 3, the application specification information is included in an IP data flow including the plurality of packages.

The reception apparatus according to an aspect 5 of the invention may be configured so that in the aspect 1, the application specification information is described in package configuration management information for managing a configuration of the package.

A reception apparatus according to an aspect 6 of the invention is a reception apparatus that receives a multiple program content in which a plurality of packages are allocated to one channel and includes: a reception unit that receives, for each of the packages, application control information for controlling an application corresponding to the package; a reproduction unit that reproduces one of the packages; and a control unit that refers to application control information corresponding to a package, which is being reproduced by the reproduction unit, to thereby activate an application corresponding to the package.

According to the aforementioned configuration, the control unit refers to the application control information corresponding to the package, which is being reproduced by the reproduction unit, to thereby activate the application corresponding to the package. Thus, the reception apparatus is able to activate, for each of packages, that is, for each of multichannels (multiple program contents), an application corresponding to the multichannel.

A transmission apparatus according to an aspect 7 of the invention is a transmission apparatus that transmits a multiple program content, in which a plurality of packages are allocated to one channel, to a reception apparatus and includes: a generation unit that generates application specification information indicating an application corresponding to each of the packages; and a transmission unit that transmits the application specification information generated by the generation unit.

According to the aforementioned configuration, the transmission unit transmits the application specification information indicating the application corresponding to each of the packages. Thus, the transmission apparatus is able to cause the reception apparatus to refer to the application specification information when one of the packages is reproduced and activate, for each of packages, that is, for each of multichannels (multiple program contents), an application corresponding to the multichannel.

A transmission apparatus according to an aspect 8 of the invention is a transmission apparatus that transmits a multiple program content, in which a plurality of packages are allocated to one channel, to a reception apparatus and includes: a generation unit that generates, for each of the packages, application control information corresponding to the package; and a transmission unit that transmits a plurality of pieces of application control information generated by the generation unit.

According to the aforementioned configuration, the transmission unit transmits the plurality of pieces of application control information corresponding to the respective packages. Thus, the transmission apparatus is able to cause the reception apparatus to refer to, when one of the packages is reproduced, the application control information corresponding to the package and activate an application corresponding to the packages. Thus, the transmission apparatus is able to cause the reception apparatus to activate, for each of packages, that is, for each of multichannels (multiple program contents), an application corresponding to the multichannel.

A transmission system according to an aspect 9 of the invention includes the reception apparatus according to any of the aspects 1 to 5 and the transmission apparatus according to the aspect 7.

According to the aforementioned configuration, the transmission system exerts an effect similar to those of the reception apparatus and the transmission apparatus.

A method for controlling a reception apparatus according to an aspect 10 of the invention is a method for controlling a reception apparatus that receives a multiple program content in which a plurality of packages are allocated to one channel. The method includes: a reception step (S12) of receiving application specification information indicating an application corresponding to each of the packages; a reproduction step (S20) of reproducing one of the packages; and a control step (S18) of activating an application corresponding to a package, which is being reproduced at the reproduction step, by referring to the application specification information received at the reception step.

According to the aforementioned configuration, an effect similar to that of the reception apparatus according to the aspect 1 is exerted.

A method for controlling a transmission apparatus according to an aspect 11 of the invention is a method for controlling a transmission apparatus that transmits a multiple program content in which a plurality of packages are allocated to one channel. The method includes: a generation step (S1) of generating application specification information indicating an application corresponding to each of the packages; and a transmission step (S3) of transmitting the application specification information generated at the generation step.

According to the aforementioned configuration, an effect similar to that of the transmission apparatus according to the aspect 7 is exerted.

The reception apparatus or the transmission apparatus according to each of the aspects of the invention may be implemented by a computer, and in such a case, a control program of the reception apparatus or the transmission apparatus, which causes the computer to operate as each of the units of the reception apparatus or the transmission apparatus to thereby implement the reception apparatus or the transmission apparatus by the computer, and a computer-readable recording medium having the control program recorded therein are also included in the scope of the invention.

The invention is not limited to each of the embodiments described above, and may be modified in various manners within the scope of the claims and an embodiment achieved by appropriately combining technical means disclosed in each of different embodiments is also encompassed in the technical scope of the invention. Further, by combining the technical means disclosed in each of the embodiments, a new technical feature may be formed.

### INDUSTRIAL APPLICABILITY

The invention is able to be used for a reception apparatus that receives a multiple program content in which a plurality of packages are allocated to one channel and a transmission apparatus that transmits the content.

### REFERENCE SIGNS LIST

1 content transmission system (transmission system)
2 transmission apparatus
3 reception apparatus
21 component multiplexing unit (generation unit, transmission unit)
34 component demultiplexing unit (reception unit)
36 audio decoding unit (reproduction unit)
37 data broadcasting control unit (control unit)
38 combining unit (reproduction unit)

1-3. (canceled)

4. A transmission apparatus that transmits a content, the transmission apparatus comprising:
circuitry that
creates an application specification descriptor and a location information, wherein the application specification descriptor associates the content with an application information table in which an information for activating an application included in the content is described, and the location information is an information for obtaining the application information table, and
sends the content and a management table in which a configuration of the content, the application specification descriptor, and the location information are described,
wherein the location information includes a packet ID and an information indicating a type of a transport path of a plurality of predetermined transport paths, wherein the transport path is used when the application information table is obtained, and the packet ID is used for obtaining the application information table at the transport path.

5. A reception apparatus that receives a content, the reception apparatus comprising:
circuitry that
obtains an application specification descriptor and a location information, wherein the application specification descriptor associates the content with an application information table in which an information for activating an application included in the content is described, and the location information is an information for obtaining the application information table, and
activates the application included in the content based on the application information table,
wherein the location information includes a packet ID and an information indicating a type of a transport path of a plurality of predetermined transport paths, wherein the transport path is used when the application information table is obtained, and the packet ID is used for obtaining the application information table at the transport path.
